(19) United States
(12) Patent Application Publication
(10) Pub. No.: US 2018/0214836 A1
(43) Pub. Date: Aug. 2, 2018

(54) CAPSULE ASSEMBLIES FOR ULTRA-HIGH PRESSURE PRESSES AND METHODS FOR USING THEM

(71) Applicants: ELEMENT SIX (UK) LIMITED, DIDCOT, OXFORDSHIRE (GB); ELEMENT SIX TECHNOLOGIES LIMITED, DIDCOT, OXFORDSHIRE (GB)

(72) Inventors: DENNIS LEONARD WELCH, SPRINGS (ZA); RAYMOND ANTHONY SPITS, DIDCOT (GB); DOUGLAS GEEKIE, DIDCOT (GB)

(21) Appl. No.: 15/745,793

(22) PCT Filed: Jul. 27, 2016
(86) PCT No.: PCT/EP2016/067878

§ 371 Date: Jan. 18, 2018

(30) Foreign Application Priority Data
Jul. 30, 2015 (GB) 1513446.3

(51) Int. Cl. B01J 3/06; C01B 21/064

(52) U.S. Cl. CPC B01J 3/065; C01B 21/064; B01J 2203/066; B01J 2203/0685; B01J 2203/062; B01J 2203/0645; B01J 2203/0655

(57) ABSTRACT

A capsule assembly for an ultra-high pressure furnace, comprising a containment tube having an interior side surface and defining a central longitudinal axis; a chamber suitable for accommodating a reaction assembly, a proximate and a distal end heater assembly, and a side heater assembly. When assembled, the chamber is contained within the containment tube and arranged longitudinally between the proximate and distal end heater assemblies. The side heater assembly is disposed adjacent the interior side surface and electrically connects the end heater assemblies with each other. Each end heater assembly has a respective peripheral side disposed adjacent the interior side surface Heat is produced in the chamber in response to an electric current flowing through the end and side heater assemblies. At least a proximate side heater barrier spaces apart the side heater assembly from at least the proximate end heater assembly, adjacent its peripheral side, operative to prevent a portion of the side heater assembly from intruding between the peripheral side of the proximate end heater assembly and the containment tube and short-circuiting at least part of the proximate end heater assembly, when the end heater assemblies move towards each other in response to a force applied by the ultra-high pressure furnace onto the capsule assembly along the central longitudinal axis.

### FIELD OF THE INVENTION

This disclosure relates generally to capsules for ultra-high pressure, high temperature (HPHT) presses, synthesis assemblies comprising the capsules and methods of using them.

### BACKGROUND

U.S. Pat. No. 8,371,212 discloses a cell assembly for use in a high-pressure cubic press used for fabricating polycrystalline diamond compacts (PDC), comprising a tubular heating element. A pressure transmitting medium extends about at least the substantially tubular heating element.

Bach, Kevin Christian (“An Improved Cube Cell Assembly for the Use With High Pressure/High Temperature Cubic Apparatus in Manufacturing Polycrystalline Diamond Compact Inserts” (2009). All Theses and Dissertations, Brigham Young University, Utah, USA. Paper 4244. Pages 7, 8) discloses a cubic press capsule assembly comprising a can assembly, a heater assembly and a cube assembly. The can assembly comprises components for sintering a polycrystalline diamond (PCD) insert and is placed inside a liner made out of isostatic material such as salt to ensure a uniform pressure distribution and to insulate the samples from grounding. The heater assembly comprises a graphite tube and a pair of graphite discs, each at a respective end of the assembly, the graphite tube and discs being capable of resistive heating in response to an electric current flowing through them. Once the heater assembly is completed, it is placed in a pressure media cube configured for accepting the insulating liner between the heater assembly and the pressure medium cube. A refractory metal disc is placed at each end of the heater assembly and a steel ring at the outermost end to conduct electric current from the anvils to the heater assembly. A pressure medium button is placed inside of each steel ring to support the steel rings from deformation, distribute pressure to the sample and insulate the anvils from the assembly heat. The heater may be formed of machined graphite. In use, the electric current flows from the steel ring to the heater assembly by a titanium or molybdenum disc. The graphite discs are placed at the ends of the heater tube, for generating end heating

### SUMMARY

There is a need for capsule assemblies suitable for ultra-high pressure, high temperature (HPHT) presses capable of synthesising ultra-hard materials, particularly but not exclusively in processes having relatively long duration, having relatively stable heater mechanisms.

Viewed from a first aspect there is provided a capsule assembly for an ultra-high pressure furnace (which may also be referred to as an ultra-high pressure press), comprising a containment tube having an interior side surface and defining a central longitudinal axis; a chamber suitable for accommodating a reaction assembly, a proximate and a distal end heater assembly, and a side heater assembly; configured such that, when assembled as in use: the chamber will be contained within the containment tube and arranged longitudinally between the proximate and distal end heater assemblies; the side heater assembly will be disposed adjacent the interior side surface and electrically connect the end heater assemblies with each other; each end heater assembly will have a respective peripheral side disposed adjacent the interior side surface; heat can be produced in the chamber in response to an electric current flowing through the end and side heater assemblies; and at least a proximate side heater barrier will space apart the side heater assembly from at least the proximate end heater assembly, adjacent its peripheral side, operative to prevent a portion of the side heater assembly from intruding between the peripheral side of the proximate end heater assembly and the containment tube and short-circuiting at least part of the proximate end heater assembly, when the end heater assemblies move towards each other in response to a force applied by the ultra-high pressure furnace onto the capsule assembly along the central longitudinal axis.

Various arrangements and combinations are envisaged for example capsule assemblies, non-limiting, non-exhaustive examples of which are disclosed below.

In some example arrangements, the capsule assembly may comprise a distal side heater barrier, configured such that, when assembled as in use the distal side heater barrier will space apart the side heater assembly from the distal end heater assembly, adjacent its peripheral side, operative to prevent a portion of the side heater assembly from intruding between the peripheral side of the distal end heater assembly and the containment tube and short-circuiting at least part of the distal end heater assembly, when the end heater assemblies move towards each other in response to a force applied by the ultra-high pressure furnace onto the capsule assembly along the central longitudinal axis. In other words, an example capsule assembly may comprise a side heater barrier corresponding to each of a proximate an distal end of the side heater assembly and the proximate and distal end heater assembly, each side heater barrier performing the same function of reducing the risk of part of the side heater assembly intruding sufficiently between the peripheral side of one or both of the end heater assemblies to short-circuit at least part of the end heater assembly.

In some example arrangements, the proximate (and in some examples arrangements, also the distal) side heater barrier may be in the form of a ring, such that when assembled as in use, the proximate (and distal) side heater barrier will be adjacent a proximate (and distal) flange portion of the side heater assembly; in which the proximate (and distal) flange portion will extend away from the interior side surface, and electrically contact the proximate (and distal) end heater assembly at a contact interface that is remote from the interior side surface and spaced apart from it by at least the proximate (and distal) side heater barrier.

In some example arrangements, the proximate (and distal) side heater barrier has a mitre surface; configured and arranged such that when assembled as in use, the mitre surface (or respective surfaces) will be disposed at an angle of at least about 10, at least about 20, at least about 30 or at least about 40 degrees with respect to the interior side surface (or the longitudinal axis); and/or the mitre surface may be disposed at an angle of at most about 80, at most about 70, at most about 60 or at most about 50 degrees with respect to the interior side surface. The (or each) mitre surface may deflect at least part of the side heater assembly away from the containment tube and maintain electrical contact between the side heater assembly and a respective end heater assembly when the end heater assemblies move towards each other under the applied force as in use. An angled area of the (or each) flange portion of the side heater assembly may be disposed against the (or the respective) mitre surface.

In some example arrangements, the proximate (and in some examples also the distal) side heater barrier may comprise or consist of electrically conductive material, or may comprise or consist of electrically insulating material. The (or each) side heater barrier may comprise or consist of material having sufficiently low coefficient of friction against the interior side surface such that it can slide against the interior side surface in use, when the capsule is under ultra-high pressure. In some example arrangements, the (or each) side heater barrier may comprise or consist of graphite, hexagonal boron nitride (hBN) or refractory metal having a melting point of at least 1,600 degrees Celsius, such as titanium (Ti), tantalum (Ta), molybdenum (Mo), tungsten (W). In some examples, each side heater barrier may comprise or consist of ceramic or mineral material, such as pyrophyllite, talc, mica, or other certain other silicate (phyllosilicate) minerals, or synthetic analogues of them. In some example arrangements, the proximate (and distal) side heater barrier comprises electrically conductive material, such as graphite.

In some example arrangements, the side heater assembly may comprise inner and outer side elements, each comprising a different electrically conducting material and capable of generating heat in response to electric current flowing through it; configured such that when assembled as in use the inner and outer side elements will be coaxial, the inner side element will be spaced apart from the interior side surface by the outer side element, and both will extend between the end heater assemblies along the entire longitudinal length of the chamber. In some example arrangements, one or more of the side heater elements may azimuthally surround the chamber.

In some example arrangements, the inner and outer side elements may each comprise or consist of material selected from graphite, refractory metal having a melting point of at least 1,600 degrees Celsius or electrically conducting carbide compounds of the refractory metal. In various examples, at least one of the side elements may comprise or consist of Ti and at least one of the side elements may comprise or consist of Ta; and/or at least one of the side elements may comprise or consist of graphite and at least one of the side elements may comprise or consist of Ti or Ta; and/or the inner side element may comprise or consist of Ti or Ta, and the outer side element may comprise or consist of graphite.

In various examples, the different materials of the inner and outer side heater elements may be such that their electrical resistivity differs by at least about 20 per cent, or by at least a factor of about two, a factor of about ten or a factor of about 100, at a temperature of about 1,000 degrees Celsius at sea level atmospheric pressure. At least one of the side heater elements may comprise or consist of metal, in elemental or alloy form; and at least one of the side heater elements may comprise or consist of graphite, which may be in the form of a rigid body or foil.

In some example arrangements, the electrical resistance of at least one of the side heater elements may increase with temperature over a range of temperatures from 25 to 1,600 degrees Celsius, and the electrical resistance of another of the side heater elements may decrease with temperature over the range of temperatures.

In some example arrangements, the side heater assembly may be configured such that when assembled as in use the inner and outer side elements can be be in electrical contact with each other over a contact interface area, and the respective materials comprised in the inner and outer side heater elements, for example graphite and titanium, will react chemically at a temperature in a range from 25 to 1,600 degrees Celsius to form an intermediate layer comprising reaction product material, for example titanium carbide.

At least one of the side elements side heater element may comprise or consist of electrically conducting carbide compound of a refractory metals, such as titanium carbide (TiC), which may arise in use from chemical reaction between metal in one of the side heater elements and carbon comprised in an adjacent end heater element. When a first heater element comprises or consists of carbon (C, such as graphite) and an adjacent second heater element comprises Ti, titanium carbide (TiC) may arise during a heating stage of a reaction process by chemical reaction of the C and the Ti. Tantalum carbide (TaC) may arise if a Ta heater element is located adjacent a graphite heater element.

In some example arrangements, at least one of the side elements may comprise or consist of graphite and a side element may comprise or consist of Ti or Ta; and/or at least one of the side elements may comprise Ti and at least one of the side elements may comprise or consist of Ta; and/or the inner side element may comprise or consist of Ti or Ta, and the outer side element may comprise or consist of graphite.

In some example arrangements, when assembled as in use, at least an area of the side of the reaction assembly may contact the inner heater element, and may comprise a salt compound such as sodium chloride or potassium bromide. For example, the outer side heater element may comprise or consist of graphite and the inner side heater element may comprise material such as titanium (Ti) that is capable of reacting with the graphite to form an intermediate layer, for example TiC, that may have the effect of protecting the graphite from reaction with and degradation by material from the reaction assembly, such as sodium chloride (NaCl), and which may have desirable electrical and resistive heating properties. An effect of the outer side heater element comprising graphite may be that the friction between the outer side heater element and the interior side surface of the containment tube is relatively low (at the high temperature and the ultra-high pressure), which may have the aspect that the capsule assembly may be compresses in use with greater uniformity of deformation across its lateral extent. This effect may be particularly evident if the outer side heater element comprises expanded graphite, in the form of flexible foil.

Heater elements comprised in the side and/or end heater assemblies may comprise different respective materials that exhibit complementary electrical properties as function of temperature. For example, the ratio of the electric currents passing through the inner and outer side heater elements in use may each vary as the temperature increases, so that the side heater assembly will exhibit a desired overall heating response, to the extent possible. In some example arrangements, the electrical resistance of one of the side heater elements may increase with temperature over a range of temperatures from 25 to 1,600 degrees Celsius, and the electrical resistance of another of the side heater elements may decrease with temperature over the range of temperatures. In other words, the side heater elements may comprise or consist of different materials, the electrical resistivity of which may change in different ways at the temperature increases from ambient (about 25 degrees Celsius) to a reaction temperature (greater than about 1,200 degrees Celsius). For example, the electrical resistivity of one of the side heater elements may decrease with temperature over a range of temperatures, which that of another heater element may increase with temperature over the range. In some examples, a side or end heater assembly may comprise a heater element comprising or consisting of graphite and another heater element comprising or consisting of titanium (Ti), tantalum (Ta) or molybdenum (Mo), the coefficient of electrical resistivity of the graphite (in response to increasing temperature) being negative up to at least about 500 degrees Celsius or up to at least about 1,000 degrees Celsius, and that of the Ti, Ta and Mo being positive up to at least the reaction temperature. For example, the side heater assembly may comprise or consist of a graphite tube or sheet, and a titanium (Ti) foil or sheet arranged in contact with the graphite tube or sheet.

In some example arrangements, at least one of the side heater elements may be in the form of a foil, sheet or layer having a thickness of at most about 0.5 millimetres (mm); and/or it may have a thickness of at least 10 nanometres (nm). In some examples, at least one of the side heater elements may comprise or consist of a tube sufficiently stiff to support itself (when handled as in assembling the capsule), and which may comprise or consist or graphite or refractory metal. The side heater element tube may have a thickness of about 0.5 mm to about 10 mm.

In some example arrangements, the ultra-high pressure furnace may be a belt-type or cubic press apparatus.

In some example arrangements, each end heater assembly may comprise a respective conduction volume forming a respective electrical path through the end heat assembly; the side heater assembly will electrically connect the respective conducting volumes to each other, and heat can be produced in the chamber in response to an electric current flowing through the conducting volumes; in which the proximate (and in some example arrangements, also a distal) end heater assembly comprises a first insulation component including an outer insulation volume; the conducting volume of the proximate (and distal) end heater assembly includes an inner conducting volume; and the inner conducting volume will be laterally spaced apart from the containment tube by the outer insulation volume.

In various example arrangements, at least the proximate end heater assembly may comprise one or more insulation volume and one or more conducting volume cooperatively configured as one or more discs and rings, arranged one within the other to form a contiguous layer assembly, extending from the central longitudinal axis to adjacent the containment tube (when assembled as in use). The insulation volume or volumes will be formed of one or more insulation components and the one or more conducting volumes will be formed of one or more conducting elements. At least one inner conducting volume may be azimuthally surrounded by at least one outer insulation volume, formed by at least a first insulation component. The inner conducting volume may be in the form of a disc or solid cylinder, and the outer insulation volume may be in the form of a ring; and the corresponding conducting element and insulation component may be in the form of a disc and a ring, respectively.

In some example arrangements, the first insulation component (of the proximate, and in some examples also the distal end heater assembly) may be in the form of a ring. The entire circumferential side area of the first insulation component may contact the containment tube, operative to constrain the entire current to flow through the inner conducting volume. In some example arrangements, all or part of the side area surface of the first insulation component may be spaced apart from the containment tube, and the conducting volume may comprise an outer conducting volume that will contact the containment tube, operative to conduct a portion of the electric current adjacent the containment tube, such that outer conducting volume is laterally (or radially) spaced apart from the inner conducting volume by the outer insulation volume.

In some example arrangements, the inner conducting volume may include the central longitudinal axis and extend to at most two thirds or to at most half of the lateral extent (e.g. the outer radius) of the end heater assembly, measured from the central longitudinal axis. The lateral dimension (e.g. radius) of the inner conducting volume may extend to at most about 35 cm, or at most about 20 cm, or at most about 10 cm, measured from the central longitudinal axis; and/or the lateral dimension (e.g. radius) of the inner conducting volume may be at least about 0.5 cm or at least about 1 cm.

In some example arrangements, the inner conducting volume may be annular in form and be arranged coaxially with the central longitudinal axis, having an outer lateral dimension (e.g. radius) that extends to at most two thirds or to at most half of the lateral extent (e.g. the outer radius) of the end heater assembly, measured from the central longitudinal axis. The outer lateral dimension (e.g. radius) of the inner conducting volume may extend to at most about 35 cm, or at most about 20 cm, or at most about 10 cm, measured from the central longitudinal axis; and/or the outer lateral dimension (e.g. radius) of the inner conducting volume may be at least about 0.5 cm or at least about 1 cm. In some examples, the inner conducting volume may be in the form of a ring having radial thickness of at least about 0.1 mm, or at least about 0.5 mm; and/or at most about 10 mm, at most about 5 mm, or at most about 1 mm. An inner insulation volume may be located within the centre of the inner conducting volume, spaced apart from the outer insulation volume by the inner conducting volume, and including the central longitudinal axis.

In some example arrangements, the outer insulation volume may be configured such that when assembled as in use, it will space apart the inner conducting volume from the containment tube by at least about 5 mm, or at least about 10 mm; or by at least 10 percent or at least 20 per cent of the inner radius of the containment tube (measured from the central longitudinal axis to the interior side surface of the containment tube). In some examples, the outer insulation volume may be annular in shape, and have a radial thickness (between an outer and inner radius) of at least about 0.5 mm or at least about 10 mm; or at least about 10 per cent or at least about 20 per cent of the outer radius; and/or the outer insulation volume may have a radial thickness of at most about 40 mm or at most about 20 mm. The outer insulation volume may be formed by an insulation component in the form of a ring.

In some example arrangements, the proximate (and distal, in some examples) end heater assembly may comprise a plurality of insulation components, cooperatively configured that they can be arranged as a tessellation (for example, one insulation component may be in the form of a ring and another insulation component may be in the form of a disc or plug, which can fit snugly within the ring, although when assembled as in use, the disc or plug may be arranged coaxial with the ring, but longitudinally spaced apart from it by a conducting element).

In some example arrangements, at least the proximate end heater assembly may comprise a plurality of end layer assemblies, each comprising or consisting of at least a first insulation component including the outer insulation volume, and at least one respective end heater element including the inner conducting volume. The end layer assemblies may be stacked longitudinally against each other; and the respective end heater elements will be in electrical contact with each other and provide a conduction path for an electric current to flow longitudinally through all of the layer assemblies.

In some example arrangements, the proximate (and distal) end heater assembly may comprise a plurality of conducting elements, and a plurality of insulation components; cooperatively configured such that when assembled as in use, the proximate end heater assembly may exhibit a substantially uniform compressive stiffness over its lateral area. In other words, the weighted mean elastic modulus of the end heater assembly at each point over its lateral area may be uniform, calculated by summing the thickness-weighted elastic moduli of each of the one or more insulation components and one or more conducting elements arranged longitudinally at that point.

In some example arrangements, the conducting volume of the proximate end heater assembly (and also the distal end heater assembly in some examples) may be formed by a plurality of end conducting elements, each comprising material selected from graphite, molybdenum (Mo), titanium (Ti), tantalum (Ta) or stainless steel.

In some example arrangements, the or each of the insulation components (of the proximate end heater assembly, and also the distal end heater assembly in some examples) may comprise ceramic material having an elastic modulus of at least about 15 gigapascals (GPa), at least about 20 GPa, or at least about 100 GPa at 25 degrees Celsius (° C.) and sea level atmospheric pressure. In some examples, the ceramic material may have an elastic modulus of at most about 500 GPa at 25 or 1,000 degrees Celsius (° C.) and sea level atmospheric pressure.

In some example arrangements, the or each of the insulation components (of the proximate end heater assembly, and also the distal end heater assembly in some examples) may comprises ceramic material having a mean thermal conductivity of at most about 100×10⁻⁶ Kcal/(cm·s.° C.), at most about 10×10⁻⁶ Kcal/(cm·s.° C.) or at most about 5×10⁻⁶ Kcal/(cm·s.° C.) at 25 degrees Celsius; or at most about 20×10⁻⁶ Kcal/(cm·s.° C.) or at most about 5×10⁻⁶ Kcal/(cm·s.° C.) at 1,000 degrees Celsius, measured at sea level atmospheric pressure. In some examples, ceramic material may have a mean thermal conductivity of at least about 1×10⁻⁶ Kcal/(cm·s.° C.) at about 25 or 1,000 degrees Celsius, measured at sea level atmospheric pressure.

In some example arrangements, the outer insulation volume may comprise electrically conducting material that is electrically isolated from the conducting volume.

In some example arrangements, the proximate and distal end heater assemblies may have substantially the same configuration as each other, and in other example arrangements the end heater assemblies may have substantially different configurations, operative to generate heat at different rates and/or according to different spatial distributions, and consequently different temperature distributions within a reaction volume in the chamber. In some example arrangements, the conduction volumes of both the proximate and distal end heater assemblies may include respective inner conducting volumes and comprise respective first insulation components including respective outer insulation volumes; and the inner conducting volumes of both end heater assemblies may be laterally spaced apart from the containment tube by the respective outer insulation volumes. The inner conducting volume of the distal end heater assembly may be spaced further apart from the containment tube than that of the proximate end heater assembly (or vice versa) operative to generate a temperature gradient within the reaction volume in use. In some examples, the inner conducting volumes of both the proximate and distal end heater assemblies be in the form of conducting discs having substantially different radii, differing by at least about 10 per cent and at most about 80 percent of the larger of the radii in some examples. In other examples, the inner conducting volumes of both the proximate and distal end heater assemblies be in the form of conducting rings having substantially different mean radii (calculated at the average of the outer and inner radii of the ring), differing by at least about 10 per cent and at most about 80 percent of the larger of the mean radii in some examples. In some example arrangements, the shapes and/or dimensions of the respective inner conducting volumes of the proximate and distal end heater assemblies may be substantially different; for example, the inner conducting volume of one of the end heater assemblies may be in the form of a conducting disc and that of the other end heater assembly be in the form of a conducting ring. In general, the configurations and arrangements of the proximate and distal end heater assemblies may differ sufficiently to generate a desired longitudinal thermal gradient within a reaction assembly in the chamber, in use.

In some example arrangements, the proximate (and in some examples arrangements, also the distal) end heater assembly may comprise a first insulation component (including the outer insulation volume) in the form of a ring; a second insulation component in the form of a disc, a first conducting element in the form of a ring, and a second conducting element that is in the form of a disc; cooperatively configured such that when assembled as in use, a first layer assembly will comprise the second conducting element coaxially accommodated within the through-hole defined by the first insulation component; a second layer assembly will comprise the second insulation component coaxially accommodated within the through-hole defined by the first conducting element; and a third layer assembly comprising at least one conducting disc; the third layer assembly can be stacked between the first and second layer assemblies and electrically connect the first and second conducting elements. In some examples, the radius of the through-hole defined by the first conducting element may be substantially equal to that defined by the first insulation component, and to the radii of the second conducting element and the second insulation component.

In some example arrangements, the first and second conducting elements may each comprise graphite, and the third conducting element comprises metallic material having melting point of at least 1,600° C. at sea level atmospheric pressure, such as Mo, Ti or Ta.

In some example arrangements, the first conducting element may have substantially the same thickness as the second insulation component, and the second conducting element has substantially the same thickness as the first insulation component. In some examples, the (or each) insulation component may have a thickness of at least 1 millimetre (mm), at least 2 mm or at least 5 mm; and/or a thickness of at most about 10 mm.

Viewed from a second aspect, there is provided a capsule assembly for an ultra-high pressure furnace, comprising a containment tube having an interior side surface and defining a central longitudinal axis, a chamber suitable for accommodating a reaction assembly, a proximate and distal end heater assembly, a side heater assembly and configured such that, when assembled as in use each end heater assembly will have a respective peripheral side that will be disposed adjacent the interior side surface; the side heater assembly will be disposed adjacent the interior side surface and electrically connect the end heater assemblies with each other; and comprise inner and outer side heater elements, each comprising different material and each capable of generating heat in response to electric current flowing through it; the chamber will be disposed between the end heater assemblies, and heat can be produced in the chamber in response to an electric current flowing through the end and side heater assemblies; in which the inner side heater element will be spaced apart from the interior side surface by the outer side heater element, and both will extend between the end heater assemblies along the entire longitudinal length of the chamber.

Various configurations and arrangements of capsule assemblies according to the second aspect are envisaged by this disclosure, including combinations with any one or more than one example arrangement disclosed in relation to the first aspect.

Viewed from a third aspect, there is provided a synthesis assembly comprising an example disclosed capsule assembly in the assembled condition and containing a reaction assembly located within the chamber; in which the reaction assembly is suitable for producing super-hard material in response to the ultra-high pressure applying an ultra-high pressure onto the reaction assembly. The super-hard material may comprises or consist of diamond or cubic boron nitride (cBN), including single crystal synthetic diamonds, single crystal cubic boron nitride, polycrystalline diamond (PCD) material, polycrystalline cBN (PCBN). In some examples, the synthesis assembly may be suitable for producing single crystal synthetic diamonds having a mean diameter (equivalent sphere diameter) of at least about 0.5 mm, at least about 1 mm or at least about 2 mm; and/or at most about 5 mm. In some examples, the synthesis assembly may be suitable for producing units comprising PCD material joined to cemented carbide material, which may be for cutting or breaking rock, concrete, metal, composite material, wood, asphalt, reinforced polymer material, for example.

Viewed from a fourth aspect, there is provided a method of using a disclosed example synthesis assembly, the method including using the ultra-high pressure furnace to subject the synthesis assembly to a pressure and a temperature that are suitable for generating the super-hard material, for a period of at least about 5 hours, at least about 10 hours, at least about 20 hours, at least about 48 hours, at least about 72 hours, at least about 5 days, or at least about 10 days; and/or for a period of at most about 30 days. Relatively long synthesis processes may be used to produce relatively large single crystal synthetic diamonds.

Non-limiting example arrangements will be described with reference to the accompanying drawings, of which

### BRIEF DESCRIPTION OF THE DRAWINGS

FIG. 1 and FIG. 2 show schematic longitudinal cross section views of example capsule assemblies, as well as part of the gaskets and parts of a pair of anvils and a die of a belt-type press;

FIG. 3 shows a schematic longitudinal cross section view of an example capsule assembly, including part of the electrode assemblies and gaskets;

FIG. 4A shows a schematic longitudinal cross section view of an example capsule assembly arrangement, including part of the electrode assemblies and gaskets; and FIG. 4B shows an expanded view of part of the example heater assembly indicated as ‘H’ in FIG. 4A;

FIG. 5A shows a schematic longitudinal cross section view of a part of an example heater assembly arrangement, region C of which is shown in more detail in FIG. 5B;

FIG. 6A shows a schematic longitudinal cross section view of part of an example capsule assembly arrangement, region D of which is shown in more detail in FIG. 6B;

FIG. 7 presents a graph showing the electrical resistivity of molybdenum as a function of temperature in the range about 25 to 2,700 degrees Celsius, at sea level atmospheric pressure;

FIG. 8 presents a graph showing the electrical resistivity of 99.9 per cent pure titanium as a function of temperature in the range about 25 to 1,050 degrees Celsius, at sea level atmospheric pressure; and

FIG. 9 presents a graph showing the electrical resistivity of an example of graphite foil as a function of temperature in the range about 0 to 2,000 degrees Celsius, at sea level atmospheric pressure.

### DETAILED DESCRIPTION

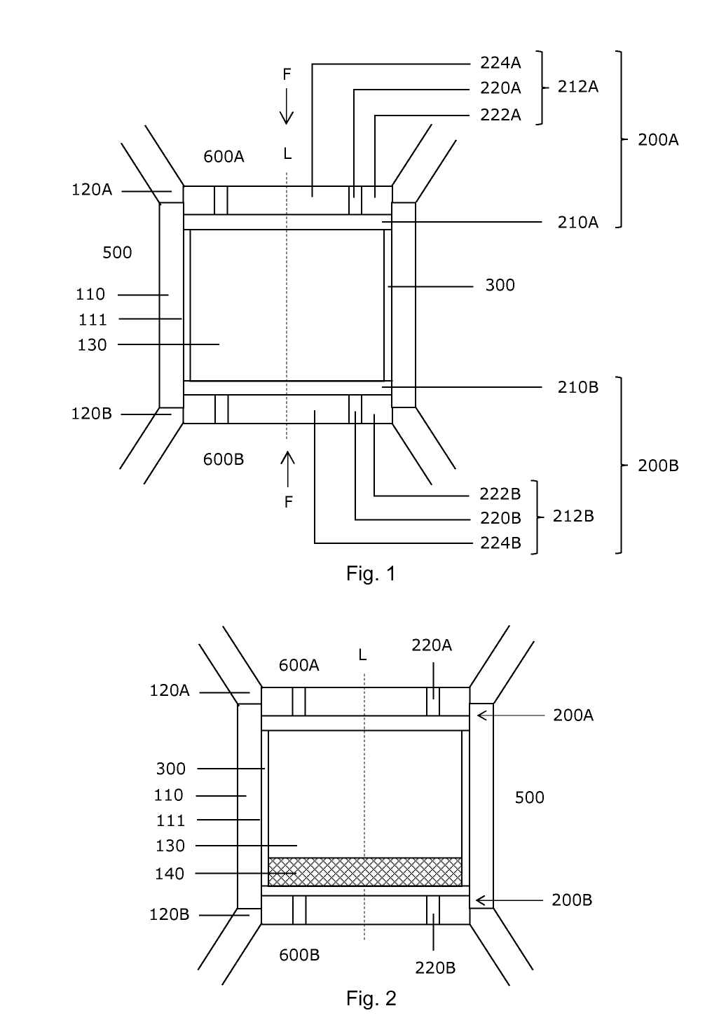

With reference to FIG. 1 and FIG. 2, example capsule assembly arrangements for a belt-type ultra-high pressure press may comprise a cylindrical containment tube 110 having an interior side surface 111, a pair of gaskets 120A, 120B, a cylindrical chamber 130 suitable for accommodating a reaction assembly (not shown), a pair of end heater assemblies 200A, 200B, and a side heater assembly 300. The containment tube 110 and the gaskets 120A, 120B may comprise natural or synthetic mineral material such as talc, pyrophyllite (a mineral comprising aluminium silicate hydroxide, Al₂Si₄O₁₀(OH)₂), mullite or other phyllosilicate minerals or material comprising aluminium (Al) and silicon (Si), and which is relatively refractory in response to high temperatures and ultra-high pressure. The containment tube defines a central longitudinal (cylindrical) axis L, along which the anvils 600A, 600B will move towards each other in use, to compress and pressurise the capsule assembly.

The chamber 130 is shown located between the two end heater assemblies 200A, 200B. In the particular arrangement illustrated in FIG. 1, each end heater assembly 200A, 200B is located adjacent an opposite end of the chamber 130, such that the chamber 130 is located substantially mid-way between the end heater assemblies 200A, 200B. In the particular example illustrated in FIG. 2, a distal end heater assemblies 200B is spaced apart from a distal end of the chamber by a spacer plug 140, such that the chamber 130 is located more closely to the proximate end heater assembly 200A and an axial temperature gradient will be generated within the chamber 130 in use. In some examples, the spacer plug 140 may comprise sodium chloride (NaCl), potassium bromide (KBr), or phyllosilicate mineral such as pyrophyllite, talc, mica or mullite. When assembled as in use and as illustrated in FIG. 1 and FIG. 2, each end heater assembly 200A, 200B will abut and electrically contact a respective anvil 600A, 600B of the ultra-high press.

The die 500 and anvils 600A, 600B may comprise cobalt-cemented tungsten carbide (WC—Co) material. In use, the anvils 600A, 600B will exhibit a dual function of compressing the capsule assembly and of delivering electric current to flow through the capsule assembly. Each anvil 600A, 600B will abut and electrically contact a respective end heater assembly 200A, 200B, and the anvils 600A, 600B will be urged by a hydraulic mechanism to move towards each other along a longitudinal axis L of the capsule assembly, thus applying opposing forces F along the longitudinal axis L and compressing the capsule assembly between them. In use, heat will be generated within the chamber 130 in response to an electric current flowing through the end heater assemblies 200A, 200B and the side heater assembly 300. In a belt-type press, the capsule assembly will be contained by an annular die 500 surrounding the containment tube 110, and by the gaskets 120A, 120B compressed between each anvil 600A, 600B and a respective end of the die 500. The gaskets 120A, 120B will comprise material capable of allowing the anvils 600A, 600B to advance on the die under sufficiently high forces, whilst preventing the contents of the capsule assembly from exploding outwards at the ultra-high pressure. In cubic-type presses (not illustrated) the capsule assembly will be compressed from six four sides, respectively, by six anvils, and gaskets will be located between neighbouring anvils.

In the example arrangements illustrated in FIG. 1 and FIG. 2, each end heater assembly 200A, 200B comprises a respective lateral heater assembly 210A, 210B and a respective end electrode assembly 212A, 212B. Each end electrode assembly 212A, 212B may comprise a respective steel electrode ring 220A, 220B located radially between a respective insulation ring 222A, 222B and insulation plug 224A, 224B. Each lateral element assembly 210A, 210B may comprise one or more electrically conducting end heater element, which may be configured and arranged to direct electric current to flow through the lateral heater assembly 210A, 210B such as to generate heat according to a desired radial configuration. Each lateral heater assembly 210A, 210B extends laterally (radially) across the interior of the containment tube 110, a peripheral side of each lateral heater assembly 210A, 210B contacting the interior side surface 111 in use. Both lateral heater assemblies 210A, 210B are thus contained by the containment tube 110, and the insulation ring 222A, 222B of each end electrode assembly 212A, 212B is partly inserted into the tube 110, also contacting its interior side surface 111. In use, each electrically conducting ring 220A, 220B will electrically connect the corresponding lateral heater assembly 210A, 210B to the corresponding (electrically conducting) anvil 600A, 600B, thus allowing electric current to flow between each anvil 600A, 600B and the proximate lateral heater assembly 210A, 210B.

In general, it will likely be desired to retain as much as possible of the heat generated by the end heater assemblies 210A, 210B and the side heater assembly 300 within the capsule assembly, minimising the amount of heat lost to the surrounding anvils 600A, 600B and die 500. Therefore, each end electrode assembly 212A, 212B may be configured such that most of its volume (more than 90 per cent of its volume, for example) consists of material that is electrically insulating and exhibits a low thermal conductivity.

This material may have a sufficiently high elastic modulus at temperatures of about 1,000 to 2,000 degrees Celsius in order to reduce distortion of the capsule assembly in use as much as possible. In the example arrangements shown in FIG. 1 and FIG. 2, the combined volume of the insulation rings 222A, 222B and insulation plugs 224A, 224B may be much greater than the volume of the electrode rings 220A, 220B.

In use, the material comprised in the containment tube 110, the insulation plugs 224A, 224B and the insulation rings 222A, 222B will likely undergo phase changes in response to being heated and pressurised over the period of a reaction process, which will likely alter their thermal conductivity properties and result in some shape distortion of the capsule assembly. Minerals such as pyrophyllite will progressively undergo phase changes over a period of time when exposed to high temperatures and pressures, resulting in changing specific gravity and thermal insulation properties. The phase change will likely begin close to the hottest region of the side heater assembly 300 and the lateral heater assemblies 210A, 210B. This phenomenon will likely be particularly important for long reaction processes, which may take several days or weeks to complete and may be a relevant consideration when designing the end and side heater assemblies 200A, 200B, 300.

In the particular examples illustrated in FIG. 1 and FIG. 2, the conducting volumes of both the proximate and distal end heater assemblies 200A, 200B comprise the heater elements in the respective lateral heater assemblies 210A, 210B and the respective steel rings 220A, 220B. The steel rings 220A, 220B form the respective inner conducting volumes of the end heater assemblies 200A, 200B, and each insulation ring 222A, 222B (corresponding to a respective first insulation component) forms the respective outer insulation volumes, which radially space apart the respective steel rings 220A, 220B (the conducting inner volumes) from the containment tube 110. This ‘choke’ arrangement will force all the electric current flowing through the anvils 600A, 600 to flow radially inward through each end heater assembly 200A, 200B, spaced radially apart from the containment tube 110. The current, which may be a low frequency alternating current, will thus be introduced into each lateral heater assembly 210A, 210B radially inward from the containment tube, ensuring that some heat will be generated as the current flows radially through the lateral heater assemblies 210A, 210B, thus heating a reaction assembly in the chamber 130 relatively closer to the central longitudinal axis L.

As electric current passes through electrically conducting elements of the lateral heater assemblies 210A, 210B and the side heater assembly 300, heat will be generated by resistive heating (also referred to as ‘Joule’ or ‘Ohmic’ heating), the amount of heat generated per unit time being proportional the square of the current multiplied by the electrical resistance of the element. The heat generated in the chamber 130 will be spatially distributed according to the configuration of the heater elements and consequently the flow of the electric current around the chamber 130.

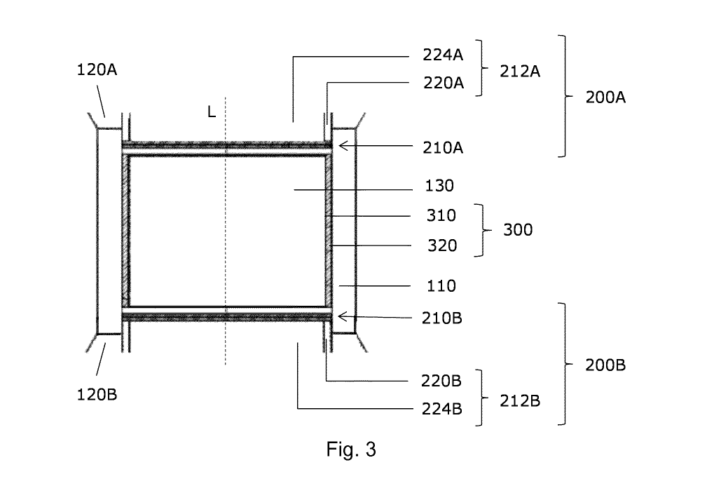

With reference to FIG. 3, an example capsule assembly may comprise a pair of end electrode assemblies 212A, 212B, each comprising a respective insulation plug 224A 224B comprising pyrophyllite and located within a respective steel electrode ring 220A, 220B. In the example arrangement illustrated in FIG. 3, the steel electrode rings 220A, 220B will define the outer peripheral side of each end electrode assembly 212A, 212B, and will be in sliding contact with the interior side surface 111 of the containment tube 110. Each lateral heater assembly 210A, 210B may comprise one or more end heater elements in the form of circular discs consisting of stainless steel and outer diameter about the same as that of the electrode rings 220A, 220B. The side heater assembly 300 may comprise a radially inner metal foil 310 and a radially outer graphite tube 320. The metal foil 310 and the graphite tube 320 each form a respective electrical connection between the lateral heater assemblies 210A, 210B, extending axially all the way between them. The metal foil 310 may consist of titanium (Ti) and extend azimuthally all the way around the chamber 130, contacting an electrically insulating side of the reaction assembly when assembled as in use. The graphite tube 320 will form a sleeve between the containment tube 110 and the Ti foil 310. The electrical resistivity of the graphite tube 320 and of the Ti foil 310 will differ substantially in their respective values and the way in which these values will change as functions of temperature between ambient temperature (about 25 degrees Celsius) and a reaction process temperature (about 1,400 degrees Celsius).

Configuring the side heater assembly 300 such that both the graphite tube 320 and the metal foil 310 extend axially all the way between the lateral heater assemblies 210A, 210B may result in a more uniform longitudinal distribution of the phase change in the containment tube 110, and potentially a lower and more stable longitudinal thermal gradient during a relatively long reaction process. The graphite comprised in the heater tube 320 will likely exhibit relatively low friction against the interior side surface 111 of the containment tube 110, and will likely be capable of sliding against it as the heater tube 320 is axially compressed in use, thus potentially permitting the capsule assembly to be compacted in a relatively uniform way, when viewed in longitudinal cross section through the central longitudinal axis L.

With reference to FIG. 3, as the temperature of the side heater assembly 300 increases above a certain value, Ti in the foil 310 will react chemically with the graphite heater tube 320 to form a thin intermediate layer of titanium carbide (TiC), thus transforming the double-layer side heater assembly 300 into a triple-layer assembly comprising an innermost layer of substantially pure Ti, the intermediate TiC layer (not shown in FIG. 3) and an outer layer of graphite. Since TiC has a much higher melting point than Ti and its electrical, chemical and mechanical properties are more stable than those of Ti at high temperatures, the formation of the TiC may likely have a stabilising effect on the side heater assembly 300.

Some example reaction assemblies located in the chamber 130 may comprise sodium chloride salt (NaCl) housing in contact with the Ti foil 310, which may protect the graphite tube 320 from being chemically degraded by the salt, which would likely alter its electrical properties. In particular, TiC is more resistant to corrosion and chemical reaction with the NaCl or other reactive materials comprised in the reaction assembly. In addition, TiC will conduct electric current and likely contribute as a third heater element within the side heater assembly 300, in parallel with the unreacted portions of the Ti foil 310 and graphite tube 320. The Ti foil 310 and TiC film will likely act as chemical barriers preventing molten salt from diffusing through the graphite heater tube 320 and interfering with its heating function. In addition, if molten salt were to diffuse through the graphite tube 320, the gaskets 120A, 120B may not be able to contain the capsule contents and material may explosively escape from the capsule assembly at ultra-high pressure (referred to as a ‘blow-out’). The reaction process will likely be aborted, and the anvils 600A, 600B and die 500 may be damaged at substantial cost.

The combined arrangement of the graphite tube 320 and the Ti heater foil 310 described with reference to FIG. 3 thus balances the need for a desired overall resistive heating response, reduced risk of chemical degradation over the duration of the reaction process, reduced temperature gradients within the reaction assembly and reduced longitudinal variation of phase change in the containment tube 110.

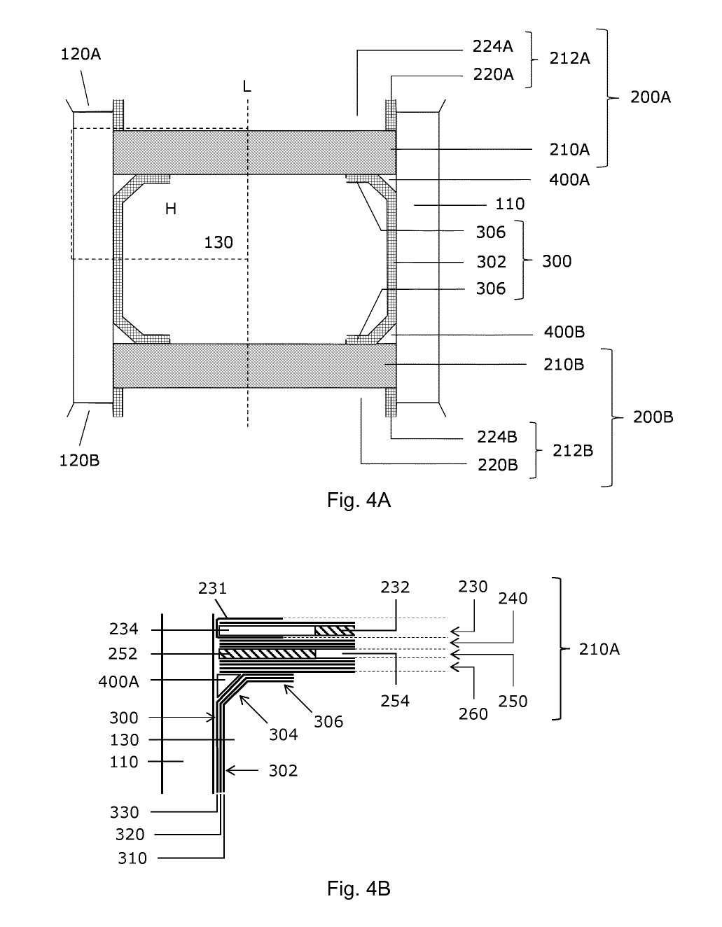

With reference to FIG. 4A and FIG. 4B, an example capsule assembly may comprise a pair of side heater barriers 400A, 400B, each located adjacent the interior side surface of the containment tube 110, between the respective lateral heater assembly 210A, 210B adjacent its peripheral side and a respective end of the side heater assembly 300. The side heater barriers 400A, 400B may be in the form of circular rings, each having an inwardly-facing mitre surface, angled at about 45 degrees with respect to its outer circumferential side surface (and the interior side surface of the containment tube 110). When viewed in cross section perpendicular to the plane of each barrier ring 400A, 400B and through its centre, the barrier may exhibit substantially a right angled triangular shape, in which the mitre surface defines the hypotenuse. When assembled, the circumferential side surface may abut the interior side surface of the containment tube 110, the adjacent right angled surface may abut the lateral heater assembly 210A, 210B, and the mitre surface may abut an angled portion 304 of the side heater assembly 300. Each barrier ring 400A, 400B will thus space apart the side heater assembly 300 from the respective lateral heater assembly 210A, 210B adjacent the containment tube 110. The barrier rings 400A, 400B may consist of graphite or other relatively refractory electrically conducting material, or they may comprise electrically insulating material such as ceramic.

In the particular example arrangement illustrated in FIG. 4A and FIG. 4B, the side heater assembly 300 may be generally cylindrical in shape and comprise a longitudinally extending side portion 302, as well as flange portions 306A, 306B at either end, folded radially inwards. Angled portions 304 of the side heater assembly 300 connecting each flange portion 306A, 306B may abut the mitre surfaces of the respective barrier rings 400A, 400B. The flange portions 306A, 306B of the side heater assembly 300 may contact the respective lateral heater assemblies 210A, 210B radially inward from the containment tube 110, at a contact area spaced radially apart it by the respective barrier rings 400A, 400B. In other example arrangements, the ends of the side heater assembly 300 may establish electrical contact with each lateral heater assembly 210A, 210B indirectly, through the respective barrier rings 400A, 400B (provided that the barrier rings 400A, 400B are electrically conductive).

The barrier rings 400A, 400B may reduce the risk of material of the side heater assembly 300 intruding between the peripheral side of the lateral heater assemblies 210A, 210B and the interior side surface of the containment tube 110 in use, especially during a relatively long reaction process. Thus, the barrier components 400A, 400B may improve the mechanical and electrical stability of the capsule assembly in use. If the barrier rings (or other forms of side heater barriers) 400A, 400B consist of graphite—or substantially of sp2-bonded carbon material generally—then the friction between the barrier ring and the interior side surface of the containment tube 110 will be relatively low at the ultra-high pressure and high temperature in use, allowing the barrier rings 400A, 400B to slide longitudinally against the containment tube 110 in use when the capsule assembly is being compressed by the anvils. This may have the aspect of reducing radial differences in pressure and deformation of the capsule assembly, increasing the likelihood of the capsule assembly compressing longitudinally in a relatively uniform way.

With reference to FIG. 4B, the part of the example capsule assembly indicated as ‘H’ in FIG. 4A is illustrated in more detail. The side heater assembly 300 may comprise three substantially conformal metal heater elements arranged co-axially, one within the other. The outermost and middle heater elements 330, 320 may consist of the same metal, for example a tantalum (Ta), and the innermost heater element 310 adjacent the chamber 130, may consist of a titanium (Ti) foil.

Each end heater assembly 200A, 200B illustrated in FIG. 4A and FIG. 4B comprises a respective end electrode assembly 212A, 212B and a respective lateral heater assembly 210A, 210B, the electrically conducting elements of which will form the respective conducting volume when arranged as illustrated. The end electrode assemblies 212A, 212B comprise respective conducting rings 220A, 220B, which may consist of stainless steel, and electrically insulating discs 224A, 224B, which may consist of pyrophyllite, located with the rings 220A, 220B. The electrically conducting rings 220A, 220B may contact the interior side surface of the containment tube 110, and will conduct electric current between the anvils and the respective lateral heater assembly 210A, 210B, introducing the current into an outer conducting volume formed by a graphite ring 234. Each end heater assembly 200A, 200B may comprise an outer insulation volume formed by an insulation ring 252, which may consist of pyrophyllite, and an inner conducting volume formed by a graphite disc 254, which fits snugly within the outer insulation ring 252 and is spaced radially apart from the containment tube 110 by the insulation ring 252. A third conducting volume 240 formed by molybdenum discs, for example, may electrically connect the graphite ring 234 and the graphite disc 254. In this arrangement, the current flowing from the anvil, through the stainless steel ring 220A, 220B and into the graphite ring 234 will be forced to flow radially inwards from the containment tube 110, through the centrally located graphite disc 254. A fourth conducting volume 260 may electrically connect the graphite ring 254 to the side heater assembly 300.

Each lateral heater assembly 210A, 210B may comprise four layer assemblies 230, 240, 250, 260, all comprising at least one electrically conducting heater element. The insulation components 232, 252 within the respective layer assemblies 230 and 250 are configured as a disc and a ring, respectively, such that the outer diameter of the disc 232 is substantially equal to the inner diameter of the ring 252. The insulation disc 232 and the insulation ring 252 may consist of the same kind of material, having substantially the same elastic modulus. When the insulation disc 232 and ring 252 are arranged coaxially as in use, they may appear from top and bottom views as forming a single tessellation disc. The layer assembly 230 may be partly encapsulated within a metal jacket 231. Viewed from the side, the insulation disc 232 and ring 252 will appear longitudinally spaced apart from each other by an intermediate layer assembly 240, consisting of molybdenum (Mo) discs having substantially the same diameter as the outer diameter of the insulation ring 252. The layer assembly 230 comprising the insulation disc 232 may also comprise an electrically conducting heater element in the form of a graphite ring 234, surrounding the insulation disc and substantially overlaying the insulation ring 252 in the layer assembly 250. The layer assembly 250 may also comprise an electrically conducting heater element in the form of a graphite disc 254, located within the insulation ring 252 and substantially underlying the insulation disc 232 in the layer assembly 230. As a result of the coaxial, cooperative nesting of the insulation ring 252 and insulation disc 232, as well as the graphite ring 234 and graphite disc 254, the longitudinal stiffness and compression response of the layer assemblies 230, 240 and 250 may be substantially invariant with radial position.

End heater assemblies of the kind described above with reference to FIGS. 4A and 4B, in which electric current is forced by a generally annular insulation component (or an equivalent configuration of insulation components) to flow laterally inward and outward may be referred to as a ‘choke’ heater assembly, since the current path may have the appearance of being ‘choked’ when viewed in longitudinal cross section. In other words, the current will be distributed over a relatively wide outer area at one or more longitudinal positions within a heater assembly, and will be concentrated over a relatively small area (usually nearer and co-axially with the central longitudinal axis) at other longitudinal positions within the heater assembly. In some examples, the current density (and consequently the rate of heat generation per unit area or volume of the heater assembly) may be substantially greater within a laterally inner volume of the heater assembly than in a laterally outer volume. In other examples, the choking of the current within an inner volume may be compensated by the heater elements of the inner volume being thicker than in the outer volume, so that the difference in current density (per unit volume) is reduced or substantially eliminated. A choke heater arrangement may thus be used to stiffen the heater assembly substantially uniformly over its lateral extent, thus reducing the degree of deformation of the heater assembly in use, and potentially (but not necessarily) to establish a lateral variation in the current density and heat generation, as in the example described with reference to FIG. 4A and FIG. 4B.

In examples of choke heaters such as illustrated in FIG. 4A and FIG. 4B, in which the current density is concentrated within a central heater element 254, the generation of heat will also be concentrated near the central longitudinal axis. In general, the temperature of a reaction assembly within the chamber 130 may be highest within a generally annular volume adjacent the side heater assembly 300 and lowest within a central volume remote from the side heater assembly 300 and the end heater assemblies 200A, 200B. Axial and radial steady-state temperature gradients will tend to be thus established within the reaction assembly in use, unless the heater assemblies are arranged to counteract this tendency. Heat will tend to be lost from the capsule assembly through the containment tube 110 and the electrode assemblies 212A, 212B, especially through the electrically conducting rings 220A, 220B. The temperature gradients can be reduced by configuring the end heater assemblies 200A, 200B to comprise choke arrangements and concentrating heat generation near the longitudinal axis L. However, in some examples that heater assemblies may be configured in order to result in a particular desired temperature gradient field within a reaction assembly, such as when diamond crystals are to be grown by a method including the dissolution of small diamond grains and the precipitation of solute carbon onto growing diamonds located in another region of the capsule (the spacer component 140 illustrated in FIG. 2 may achieve a desired longitudinal temperature gradient by spacing one of the heater assemblies 200B further away from the chamber 130 than the other heater assembly 200A).

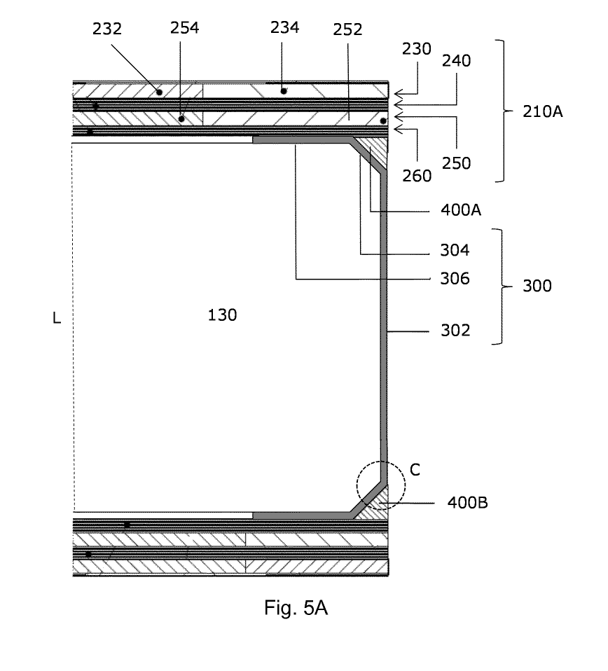

With reference to FIG. 5A and FIG. 5B, an example capsule assembly may comprise a side heater assembly 300 comprising four substantially conformal, generally annular metal heater elements 310, 320, 330, 340 arranged co-axially, one within the other. The outermost 350 and innermost 310 heater elements of the side heater assembly 300 may consist of titanium (Ti), and the two innermost heater elements 320, 330 may consist of tantalum (Ta). The end heater assemblies comprises respective lateral heater assemblies 210A, 210B, each comprising four layer assemblies 230, 240, 250, 260, configured and arranged as chokes. The longitudinally innermost layer assembly 260 may consist of circular Mo wafers stacked one against the other. The axially innermost of these may contact the outermost Ti layer 340 of the flange portion 306 of the side heater assembly 300, and abut the respective support ring 400A, 400B. The adjacent layer assembly 250 may consist of an electrically insulating ring 252 comprising pyrophyllite, forming the outer insulation volume, and an inner graphite disc 254, forming the inner conducting volume spaced apart from the containment tube 110 by the first conducting volume. The next layer assembly 240 may consist of Mo wafers stacked against each other. The fourth layer assembly 230 may consist of an electrically conducting ring 234 comprising graphite and an inner electrically insulating disc 232 comprising pyrophyllite, configured to force electric current to flow radially outward as it passes through the fourth layer assembly 230.

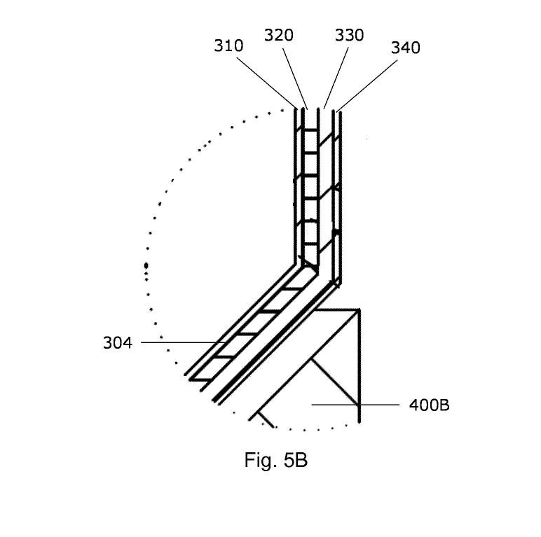

With reference to FIG. 6A and FIG. 6B, example end electrode assemblies 212A, 212B may comprise respective steel discs 215A, 215B, an electrically insulating ring 222A, 222B, an electrically insulating disc 224A, 224B and an electrically conducting ring 220A, 220B (forming the conducting inner volume), located between the electrically insulating rings 222A, 222B (forming the outer insulation volume) and discs 224A, 224B. The electrically insulating rings 222A, 222B and discs 224A, 224B may comprise pyrophyllite and be arranged coaxially. The electrically conducting ring 220A, 220B may comprise Mo and when the end electrode assemblies 212A, 212B are assembled as in use, the conducting rings 220A, 220B will electrically connect the respective steel discs 215A, 215B and the corresponding lateral heater assembly 210A, 210B. The location of each Mo ring 220A, 220B radially inward from the containment tube 110 will have the effect of ‘choking’ the electric current that will flow between the anvils and the lateral heater assemblies 210A, 210B, and thus introduce the current to the lateral heater assemblies 210A, 210B radially inward from the containment tube 110. This will have the effect of ensuring that heat will be generated within the lateral heater assemblies 210A, 210B as close to the longitudinal axis L of the heater assembly as desired.

With reference to FIG. 6B, a lateral heater assembly 210A may comprise a plurality of stacked discs 235, 237 consisting of graphitic foil material and having different diameters. The graphitic discs 235 closer to the end electrode 212 have a greater diameter than those 237 further away from it, contacting the edge of the side heater sleeves 300 at the peripheral circumference. The difference in the diameters if the end heater disc elements 235, 237 may reduce the difference in the density of the current flowing through them across their lateral extent. In other words, although the lateral area density of the current may be lower through the peripheral area than through the central area, this may be at least partly compensated by the overall thickness of the combined disc elements 235, 237 within the central area, thus reducing the differences in the current density and rate of heat generation per unit volume of the lateral heater assembly 210. The side heater assembly 300 may comprise one or more sleeves consisting of graphitic foil material.

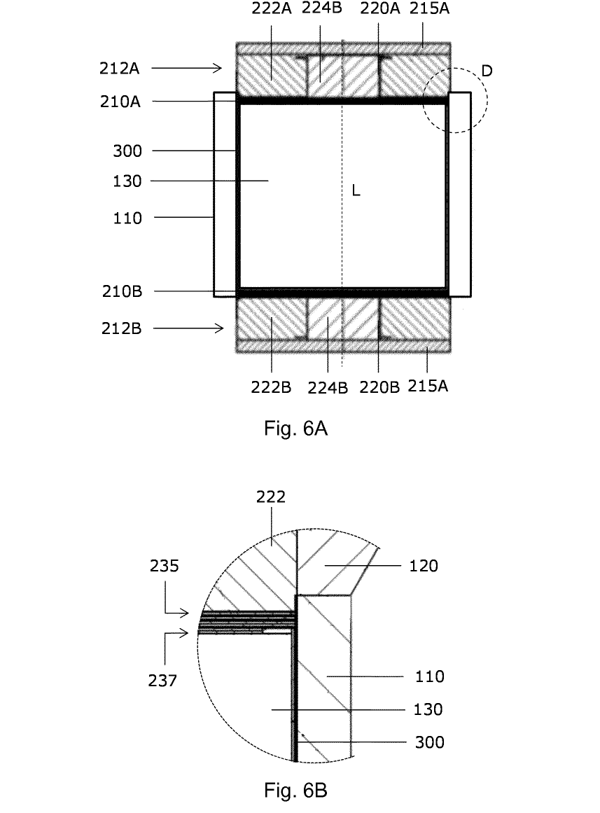

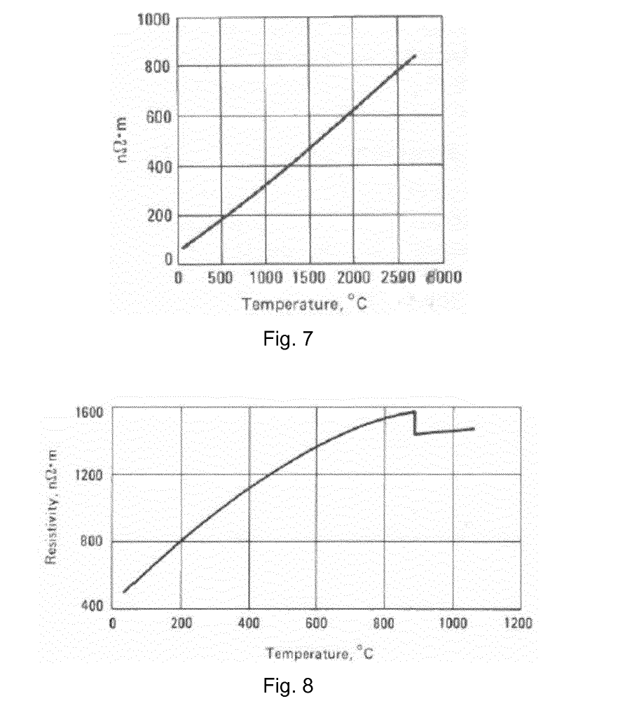

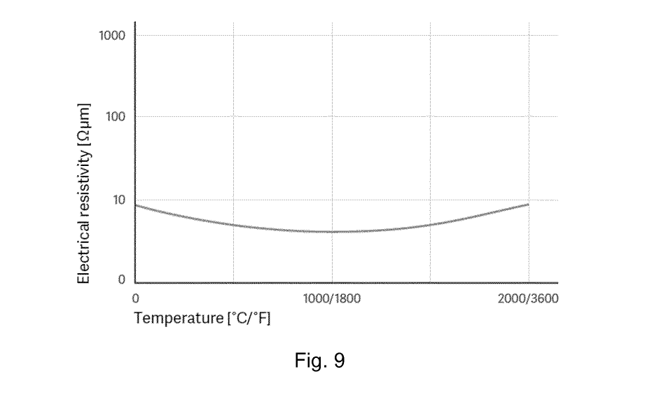

With reference to FIG. 7, FIG. 8 and FIG. 9, the elements of a heater assembly, particularly the side heater assembly, may comprise different materials having substantially different electrical resistivity, which may respond substantially differently to changes in temperature. For example, the electrical resistivity of Mo and Ti increases monotonically as function of increasing temperature up to at least about 850 degrees Celsius and above about 900 degrees Celsius, as shown in FIG. 7 and FIG. 8, whereas the electrical resistivity of certain graphitic foil decreases with increasing temperature up to about 1,000 degrees Celsius and then begins to increase with temperature above about that temperature, as shown in FIG. 9. Therefore, Ti or Mo foil may be combined with graphitic foil to form a side heater assembly, the thicknesses of metal and graphitic foils being selected to achieve a desired overall electrical resistivity for the heater assembly as a function of temperature.

In various examples, the arrangement and configurations of the end and side heater assemblies may be selected to reduce the gradient of the temperature axially and/or radially within the reaction assembly when at the ultra-high pressure, to increase the likelihood of achieving sufficiently uniform sintering throughout the sinter assembly (which may be configured for sintering a plurality of separate units). Additional considerations in designing the capsule assembly and the heater assembly in particular may be ease of assembly and reduction of variation between assemblies, and/or the duration of the reaction process.

Example arrangements of capsule assemblies may have the aspect that the heater assemblies would likely exhibit relatively stable heat generation behaviour in use, which may arise from relatively good mechanical and chemical stability despite the application of high loads (and consequently ultra-high pressures) and temperatures to the capsule assembly. This aspect may be particularly (but not exclusively) helpful if an example capsule assembly is used in relatively long reaction processes for synthesising relatively large diamond or cubic boron nitride (cBN) crystals; or in reaction processes for sintering diamond or cBN grains to make polycrystalline diamond (PCD) or polycrystalline cBN (PCBN) material, respectively, especially where a high degree of dimensional accuracy is desirable.

In various example arrangements, the end and/or side heater assemblies may comprise one or more heater elements in the form of layers or sheets, configured and arranged such that each heater assembly has desired overall electrical characteristics, suitable for resistively generating heat and heating a reaction assembly in the chamber to desired temperatures and temperature gradients. The heater elements may comprise various different materials, selected for their electrical, mechanical and chemical properties, such that when combined with each other in a particular configuration, the heater assembly as a whole exhibits the required electrical, thermal, mechanical and chemical characteristics. An example of a chemical characteristic may be substantial resilience against engaging in chemical reactions with adjacent material and thus substantial constancy of the electrical properties throughout a reaction process. The side and end heater assemblies may be configured to minimise radial and/or axial temperature gradients within the reaction assembly, or to achieve a desired radial and/or axial temperature gradient.

In some examples, the material comprised in one of the heater elements may have the effect of protecting another of the heater elements from chemical reaction with another component; in some examples, the material comprised in adjacent heater elements may react chemically with each other during a reaction process, particularly in the early stages of a process, to form a protective layer comprising or consisting of reaction product material, which may form a protective layer and/or have desirable electrical properties.

Certain terms and concepts as used herein will be briefly explained.

As used herein, an ultra-high pressure is a pressure of at least 1 GPa. For practical purposes, ultra-high pressure used in industrial reaction processes may be at most about 15 GPa, at most 10 GPa or at most about 8 GPa. As used herein, an ultra-high pressure furnace (which may also be referred to as an ultra-high pressure press) is an apparatus capable of subjecting a reaction assembly to at ultra-high pressure and a mean temperature of at least about 1,000 degrees Celsius.

As used herein, the words ‘ring’, tube’, ‘annular’ and the like do not necessarily imply circular or cylindrical shapes, unless otherwise stated, and will generally include other forms and shapes in which an open-ended central volume is defined by a wall or interior side surrounding the volume and defining a central longitudinal axis and having rotational (but not necessarily cylindrical) symmetry about the central longitudinal axis. For example, a tube or ring viewed in cross section (laterally, perpendicular to the longitudinal axis) may be circular, annular, square, rhombohedral, polyhedral, oval, elliptical and so forth.

As used herein in relation to structures, tubes, chambers, heater assemblies, presses that are substantially symmetric about a cylindrical (also referred to as a longitudinal) axis, aspects may be described in terms of cylindrical coordinates, including radial and azimuthal coordinates. As used herein, a longitudinal axis is the axis of a capsule assembly along which a pair of anvils apply opposing forces onto the capsule assembly to pressurise it, and references to ‘lateral’ are in relation to the longitudinal axis; a lateral plane is perpendicular to a longitudinal axis. The word ‘radial’ may also be used to refer to ‘lateral’ when cylindrical coordinates are being used. ‘Longitudinal’ is not intended to imply or suggest that there are only the two anvils that define it and there may be more than the pair of anvils; it is also not intended to imply or suggest ‘vertical’, and a longitudinal axis as used herein may be vertical, horizontal, or at some other orientation with respect to gravity. Similarly, ‘lateral’ is not intended to imply or suggest ‘horizontal’ with respect to gravity. For example, a belt-type press system will have only two anvils, with lateral support for the capsule assembly being provided by a die, and a cubic press will have six anvils arranged as opposing pairs in cubic symmetry, and no die. Therefore, there are three potential longitudinal axes for a capsule assembly in a cubic press.

As used herein, references to ‘graphite’ will include graphite (single or polycrystalline graphite), material that comprises graphite or at about least 70 weight per cent graphite, flexible expanded graphite material, graphitic foil, sheet or cloth (such as may be commercially available from the SGL Group™ under the brand name Sigraflex™), or other material comprising at least about 70 weight per cent sp2-bonded carbon. Example heater elements may comprise any of certain forms of graphite, the microstructure and properties of which may depend substantially on the method used to manufacture it and the source material used. For example, graphite manufactured from petroleum coke may have electrical resistivity of about 5 to about 15 micro-Ohm metres (∥Ω·m) and exhibit a negative coefficient of electrical resistivity as function of temperature up to about 500 degrees Celsius, above which it may become positive (in other words, the electrical resistivity may decrease as the temperature increases to about 500 degrees Celsius and increase as the temperature increases above this value). Graphite manufactured from carbon black may have electrical resistivity several times higher than that made from petroleum coke and the coefficient of electrical resistivity may be negative up to at least about 1,600 degrees Celsius. Crystalline graphite will exhibit very anisotropic electrical resistivity, that in the basal plane being about 0.40 μΩ·m, and across the basal plane, being about 60 μΩ·m. Graphite used for heater elements in heater assemblies will likely be polycrystalline graphite, having substantially isotropic mean electrical resistivity, and may be in the form of a machined solid, self-supporting tube, disc or ring, or in the form of graphite foil or cloth.

As used herein, ceramic materials are inorganic, non-metallic materials made from compounds including at least one metal (for example aluminium, silicon) and at least one non-metal (for example oxygen, nitrogen, carbon). Ceramic materials including phyllosilicate materials such as pyrophyllite (aluminium silicate hydroxide: Al₂Si₄O₁₀(OH)₂), mica, mullite, kaolinite, and other ceramic materials such as magnesium oxide.

1. A capsule assembly for an ultra-high pressure furnace, comprising:
a containment tube
having an interior side surface and
defining a central longitudinal axis;
a chamber suitable for accommodating a reaction assembly,
a proximate and a distal end heater assembly, and
a side heater assembly;
configured such that, when assembled as in use:
the chamber will be
contained within the containment tube and
arranged longitudinally between the proximate and distal end heater assemblies;
the side heater assembly will
be disposed adjacent the interior side surface and
electrically connect the end heater assemblies with each other;
each end heater assembly will have a respective peripheral side disposed adjacent the interior side surface;
heat can be produced in the chamber in response to an electric current flowing through the end and side heater assemblies; and
at least a proximate side heater barrier will space apart the side heater assembly from at least the proximate end heater assembly, adjacent its peripheral side, operative to prevent a portion of the side heater assembly from intruding between the peripheral side of the proximate end heater assembly and the containment tube and short-circuiting at least part of the proximate end heater assembly, when the end heater assemblies move towards each other in response to a force applied by the ultra-high pressure furnace onto the capsule assembly along the central longitudinal axis.

2. A capsule assembly as claimed in claim 1, comprising
a distal side heater barrier,
configured such that, when assembled as in use:
the distal side heater barrier will space apart the side heater assembly from the distal end heater assembly, adjacent its peripheral side, operative to prevent a portion of the side heater assembly from intruding between the peripheral side of the distal end heater assembly and the containment tube and short-circuiting at least part of the distal end heater assembly, when the end heater assemblies move towards each other in response to a force applied by the ultra-high pressure furnace onto the capsule assembly along the central longitudinal axis.

3. A capsule assembly as claimed in claim 1, in which
at least the proximate side heater barrier is in the form of a ring,
such that when assembled as in use, at least the proximate side heater barrier will be
adjacent at least a proximate flange portion of the side heater assembly; in which
at least the proximate flange portion will
extend away from the interior side surface, and
electrically contact the proximate end heater assembly at a contact interface that is remote from the interior side surface and spaced apart from it by at least the proximate side heater barrier.

4. A capsule assembly as claimed in claim 1, in which
at least the proximate side heater barrier has a mitre surface;
configured and arranged such that when assembled as in use,
the mitre surface will be disposed at an angle of 10 to 80 degrees with respect to the longitudinal axis.

5. A capsule assembly as claimed in claim 1, in which
at least the proximate side heater barrier comprises electrically conductive material, such as graphite.

6. A capsule assembly as claimed in claim 1, in which
the side heater assembly comprises
inner and
outer side elements,
each comprising a different electrically conducting material and
capable of generating heat in response to electric current flowing through it;
configured such that when assembled as in use:
the inner and outer side elements will be coaxial,
the inner side element will be spaced apart from the interior side surface by the outer side element, and both will
extend between the end heater assemblies along the entire longitudinal length of the chamber.

7. A capsule assembly as claimed in claim 6, in which
the inner and outer side elements each comprises material selected from graphite, refractory metal having a melting point of at least 1,600 degrees Celsius or electrically conducting carbide compounds of the refractory metal.

8. A capsule assembly as claimed in claim 6, in which
at least one of the side elements comprises Ti and
at least one of the side elements comprises Ta.

9. A capsule assembly as claimed in claim 6, in which
at least one of the side elements comprises graphite and
at least one of the side elements comprises Ti or Ta.

10. A capsule assembly as claimed in claim 9, in which
the inner side element comprises Ti or Ta, and
the outer side element comprises graphite.

11. A capsule assembly as claimed in claim 6, in which
the electrical resistance of at least one of the side heater elements will increase with temperature over a range of temperatures from 25 to 1,600 degrees Celsius, and
the electrical resistance of another of the side heater elements will decrease with temperature over the range of temperatures.

12. A capsule assembly as claimed in claim 6, in which
the side heater assembly is configured such that when assembled as in use
the inner and outer side elements will be in electrical contact with each other over a contact interface area, and
the respective materials comprised in the inner and outer side heater elements, for example graphite and titanium, will react chemically at a temperature in a range from 25 to 1,600 degrees Celsius to form an intermediate layer comprising reaction product material, for example titanium carbide.

13. A capsule assembly as claimed in claim 1, in which
the ultra-high pressure furnace is a belt-type or cubic press apparatus.

14. A capsule assembly as claimed in claim 1, in which
each end heater assembly will comprise a respective conduction volume forming a respective electrical path through the end heat assembly;
the side heater assembly will electrically connect the respective conducting volumes to each other, and
heat can be produced in the chamber in response to an electric current flowing through the conducting volumes; in which
at least the proximate end heater assembly
comprises a first insulation component including an outer insulation volume;
the conducting volume of at least the proximate end heater assembly includes an inner conducting volume; and
the inner conducting volume will be laterally spaced apart from the containment tube by the outer insulation volume.

15. A capsule assembly as claimed in claim 14, in which
the first insulation component is in the form of a ring,
a peripheral side of which will abut the containment tube, operative to constrain the entire current to flow through the inner conducting volume.

16. A capsule assembly as claimed in claim 14, in which the inner conducting volume will
include the central longitudinal axis and
extend to at most two thirds of the lateral extent of the end heater assembly,
measured from the central longitudinal axis.

17. A capsule assembly as claimed in claim 14, in which
at least the proximate end heater assembly comprises
a plurality of insulation components, cooperatively configured that they can be arranged as a tessellation.

18. A capsule assembly as claimed in claim 14, in which
at least the proximate end heater assembly comprises
a plurality of conducting elements, and
a plurality of insulation components;
cooperatively configured such that when assembled as in use,
the proximate end heater assembly will exhibit a substantially uniform compressive stiffness over its lateral area.

19. A capsule assembly as claimed in claim 14, in which
the conducting volume is formed by a plurality of end conducting elements, each comprising material selected from graphite, molybdenum (Mo), titanium (Ti) or tantalum (Ta).

20. A capsule assembly as claimed in claim 14, in which
the or each of the insulation components comprises ceramic material having an elastic modulus of at least 15 gigapascals (GPa) at 25 degrees Celsius (° C.) and sea level atmospheric pressure.

21. A capsule assembly as claimed in claim 14, in which
the or each of the insulation components comprises ceramic material having a mean thermal conductivity of
at most 100×10⁻⁶ Kcal/(cm·s.° C.) at 25 degrees Celsius, or at most 20×10⁻⁶ Kcal/(cm·s.° C.) at 1,000 degrees Celsius, measured at sea level atmospheric pressure.

22. A capsule assembly as claimed in claim 14, in which
the conduction volumes of both the proximate and distal end heater assemblies include respective inner conducting volumes,
both proximate and distal end heater assemblies comprise respective first insulation components including respective outer insulation volumes; and
the inner conducting volumes of both end heater assemblies will be laterally spaced apart from the containment tube by the respective outer insulation volumes.

23. A capsule assembly as claimed in claim 22, in which
the inner conducting volume of the distal end heater assembly will be spaced further apart from the containment tube than that of the proximate end heater assembly, in all azimuthal directions, operative to generate a temperature gradient within the reaction volume in use.

24. A capsule assembly as claimed in claim 14, in which
at least the proximate end heater assembly comprises
the first insulation component in the form of a ring,
a second insulation component in the form of a disc,
a first conducting element in the form of a ring, and
a second conducting element in the form of a disc;
cooperatively configured such that when assembled as in use,
a first layer assembly will comprise
the second conducting element coaxially accommodated within a through-hole defined by the first insulation component;
a second layer assembly will comprise
the second insulation component coaxially accommodated within a through-hole defined by the first conducting element;
a third layer assembly will comprise
at least one conducting disc;
the third layer assembly can be stacked between the first and second layer assemblies, and electrically connect the first and second conducting elements.

25. A capsule assembly as claimed in claim 24, in which
the radius of the through-hole defined by the first conducting element is substantially equal to that defined by the first insulation component, and to
the radii of the second conducting element and the second insulation component.

26. A capsule assembly as claimed in claim 24, in which
the first and second conducting elements each comprise graphite, and the third layer assembly comprises metallic material having melting point of at least 1,600° C. at sea level atmospheric pressure, such as Mo, Ti or Ta.

27. A capsule assembly as claimed in claim 24, in which
the first conducting element has substantially the same thickness as the second insulation component, and
the second conducting element has substantially the same thickness as the first insulation component.

28. A capsule assembly as claimed in claim 14, in which
the or each insulation component has a thickness of at least 1 millimetre (mm).

29. A capsule assembly for an ultra-high pressure furnace, comprising:
a containment tube having an interior side surface and defining a central longitudinal axis,
a chamber suitable for accommodating a reaction assembly,
a proximate and distal end heater assembly,
a side heater assembly and
configured such that, when assembled as in use:
each end heater assembly will have a respective peripheral side that will be disposed adjacent the interior side surface;
the side heater assembly will
be disposed adjacent the interior side surface and
electrically connect the end heater assemblies with each other; and comprise inner and
outer side heater elements,
each comprising different material and
each capable of generating heat in response to electric current flowing through it;
the chamber will be disposed between the end heater assemblies, and
heat can be produced in the chamber in response to an electric current flowing through the end and side heater assemblies; in which
the inner side heater element will be spaced apart from the interior side surface by the outer side heater element, and both will
extend between the end heater assemblies along the entire longitudinal length of the chamber.

30. A capsule assembly as claimed in claim 29, comprising
a proximate and/or distal side heater barrier;
configured such that, when assembled as in use:
the proximate and/or end heater assembly will have a respective peripheral side that will be disposed adjacent an interior side surface of the containment tube;
the proximate and/or distal side heater assembly will be disposed adjacent the interior side surface; and
the proximate and/or distal side heater barrier will space apart the side heater assembly from the proximate and/or distal end heater assembly adjacent its peripheral side;
operative to prevent a portion of the side heater assembly from intruding between the peripheral side of the proximate and/or distal end heater assembly and the containment tube and short-circuiting at least part of the proximate and/or end heater assembly, when the end heater assemblies move towards each other in response to a force applied by the ultra-high pressure furnace onto the capsule assembly along the central longitudinal axis.

31. A capsule assembly as claimed in claim 30, in which
the proximate and/or distal side heater barrier is in the form of a ring;
such that when assembled as in use, the proximate and/or distal side heater barrier will be adjacent a respective proximate and/or distal flange portion of the side heater assembly; in which
the proximate and/or distal flange portion will
extend away from the interior side surface, and
electrically contact the conducting volume of the proximate and/or distal end heater assembly at a contact interface that is remote from the interior side surface and spaced apart from it by the proximate and/or distal side heater barrier.

32. A capsule assembly as claimed in claim 30, in which the proximate and/or distal side heater barrier has a mitre surface;
configured and arranged such that when assembled as in use,
the mitre surface will be disposed at an angle of 10 to 80 degrees with respect to the longitudinal axis.

33. A capsule assembly as claimed in claim 30, in which
the inner and outer side heater elements each comprises material selected from graphite, refractory metal having a melting point of at least 1,600 degrees Celsius or electrically conducting carbide compounds of the refractory metal.

34. A capsule assembly as claimed in claim 30, in which
at least one of the side heater element comprises Ti and
at least one of the side heater element comprises Ta.

35. A capsule assembly as claimed in claim 30, in which
at least one of the side heater elements comprises graphite and
at least one of the side heater elements comprises Ti or Ta.

36. A capsule assembly as claimed in claim 35, in which
the inner side heater element comprises Ti or Ta, and
the outer side heater element comprises graphite.

37. A capsule assembly as claimed in claim 30, in which
the electrical resistance of at least one of the heater elements will increase with temperature over a range of temperatures from 25 to 1,600 degrees Celsius, and
the electrical resistance of another of the side heater elements will decrease with temperature over the range of temperatures.

38. A capsule assembly as claimed in claim 30, in which
the side heater assembly is configured such that when assembled as in use
the inner and outer side heater elements will be in electrical contact with each other over a contact interface area, and
the respective materials comprised in the inner and outer side heater elements will react chemically at a temperature in a range from 25 to 1,600 degrees Celsius to form an intermediate layer comprising reaction product material.

39. A capsule assembly as claimed in claim 30, in which
the press apparatus is a belt-type or cubic press apparatus.

40. A synthesis assembly comprising a capsule assembly as claimed claim 1, in the assembled condition and containing
a reaction assembly located within the chamber; in which
the reaction assembly is suitable for producing super-hard material in response to the ultra-high pressure applying an ultra-high pressure onto the reaction assembly.

41. A synthesis assembly as claimed in claim 40, in which
the super-hard material comprises synthetic diamond or cubic boron nitride (cBN).

42. A method of using a synthesis assembly as claimed in claim 40, including
using the ultra-high pressure furnace to subject the synthesis assembly to a pressure and a temperature that are suitable for generating the super-hard material, for a period of at least 5 hours.
